(19) United States
(12) Patent Application Publication
(10) Pub. No.: US 2013/0054633 A1
(43) Pub. Date: Feb. 28, 2013

(54) REMOTE COMPARISON OF A MAINTENANCE CONFIGURATION WITH AN ALLOWABLE CONFIGURATION

(71) Applicant: CHRISTIAN BAUST, Rauenberg (DE)

(72) Inventor: CHRISTIAN BAUST, Rauenberg (DE)

(21) Appl. No.: 13/215,372

(22) Filed: Aug. 23, 2011

(51) Int. Cl. G06F 17/30

(52) U.S. Cl. 707/769; 707/E17.014

(57) ABSTRACT

Various embodiments of systems and methods for remote comparison of a maintenance configuration with an allowable configuration are described herein. According to the technique, an operator of an asset sends an as-maintained configuration of the asset to a third party. The third party receives or has in store the as-allowed configuration of the same asset. The third party performs a configuration check of the as-maintained with the as-allowed configuration and provides results.

### FIELD

The field relates to configuration maintenance. More precisely, the field relates to remotely comparing a maintenance configuration with an allowable configuration of a composite physical object.

### BACKGROUND

Highly regulated companies, for example Aerospace and Defense (A&D) and utilities industries need to comply with as-allowed asset structures to run their daily businesses. Since the as-maintained structures are changed frequently during maintenance, staying compliant with the as-allowed structures is a hard and cost intensive business for such companies.

As-maintained and as-allowed structures are well established and used objects in the industries. An as-maintained configuration also referred to as maintenance configuration is a configuration that consists of information how a complex composite object such as an aircraft, an engine or a power generator is maintained. An as-allowed configuration also referred to as allowable configuration is provided usually by the manufacturer of the composite object or the owner of the composite object. In some industries, the allowable configuration is approved by a regulating authority, for example the National Transportation Security Board (NTSB) for A&D in the United States. An allowable configuration usually consists of the parts allowed to be used as replacement parts for the composite object, as well as parts interdependence. The structure of a composite object defines its configuration. The configuration is the current asset structure and comprising parts. For an aircraft or an engine, the information for the structure and the parts are typically provided by the manufacturer of the asset in a parts catalogue or a parts list. According to the asset, information may also be provided for the functional location of the parts and their consistency. The configuration check of an as-maintained with an as-allowed configuration is done in the industries but on a paper based process or by using dedicated software applications. Either the paper based approach or using a dedicated software application has many disadvantages.

### SUMMARY

Various embodiments of systems and methods of remote comparison of a maintenance configuration with an allowable configuration are described herein. In one embodiment, the method includes receiving an operator identification from an operator of a composite object at a remote server and receiving data representing the first configuration from the operator of the composite object at the remote server. The method also includes comparing the first configuration with the second configuration of the composite object within the remote server and determining a deviation between the first configuration and the second configuration of the composite object. The method further includes presenting result data to the operator, the result data comprising the determined deviation.

In other embodiments, the system for remotely comparing a maintenance configuration to an allowable configuration of a composite object includes at least one processor for executing program code and memory, and a remote server. The system also includes a receiving module within the remote server to receive an operator identification and data representing the maintenance configuration from an operator of the composite object. The system further includes a processing module within the remote server to compare the maintenance configuration with the allowable configuration and to determine a deviation between the maintenance configuration and the allowable configuration of the composite object and a reporting module to present result data to the operator, the result data comprising the determined deviation.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram representing an embodiment of a system for remote comparison of a maintenance configuration with an allowable configuration.

FIG. 2 is a flow diagram of an embodiment of a method for remote comparison of a maintenance configuration with an allowable configuration.

FIG. 3 is a block diagram of an embodiment of a system for remote comparison of a maintenance configuration with an allowable configuration.

FIG. 4 is a block diagram illustrating a computing environment in which the techniques described for remote comparison of a maintenance configuration with an allowable configuration can be implemented, according to an embodiment of the invention.

### DETAILED DESCRIPTION

Embodiments of techniques for systems and methods of remote comparison of a maintenance configuration with an allowable configuration are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

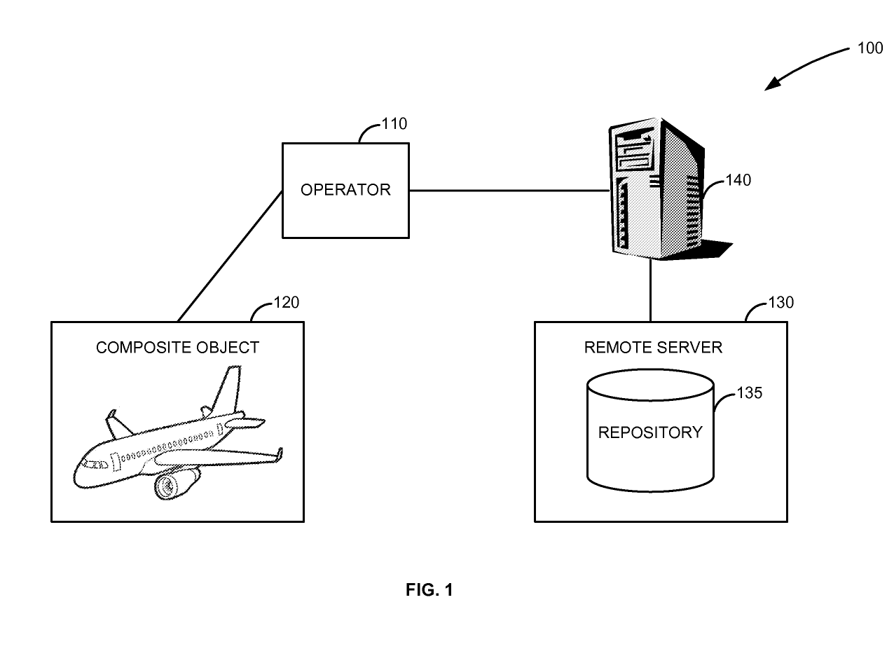

FIG. 1 represents a block diagram of an embodiment of a system 100 for remote comparison of a maintenance configuration with an allowable configuration. An operator 110 operates on a composite object 120. The operator 110 is a company or an organization that maintains the composite object 120. The composite object 120 is, for example, an asset such as an aircraft, or a complex part of the aircraft such as the engine, which is composite as well. The operator 110 of the composite object 120 is required to keep track of the actual configuration. The actual configuration may be dynamic since it depends on the actual condition of the composite object. During maintenance activities, it is often necessary to replace some parts. The technical documentation provided by the manufacturer defines all valid parts that may be installed within the composite object. Valid parts are parts that are accepted by the manufacturer, and sometimes authorized by a regulating authority, to be used within the composite object without disrupting the consistency and hence the performance of the composite object. Utilizing and maintaining a composite object conducts changes in the structure or the configuration of the composite object. The actual configuration, also called maintenance configuration or as-maintained configuration is kept within an operator's computer or server 140. In many industries, it is necessary to check if the maintenance configuration of a composite object is in compliance with some allowable configuration. The allowable configuration is typically based on the information provided by the manufacturer of the asset. The allowable configuration consists of all valid parts of a composite object and the parts consistency. According to one embodiment, the allowable configuration may be kept with a third party service provider. For instance, in FIG. 1, the allowable configuration for the composite object 120 is kept in a repository 135 of a remote server 130. The remote server 130 is connected to the operator's server 140, so that the maintenance configuration may be sent and compared to the allowable configuration within the remote server 130.

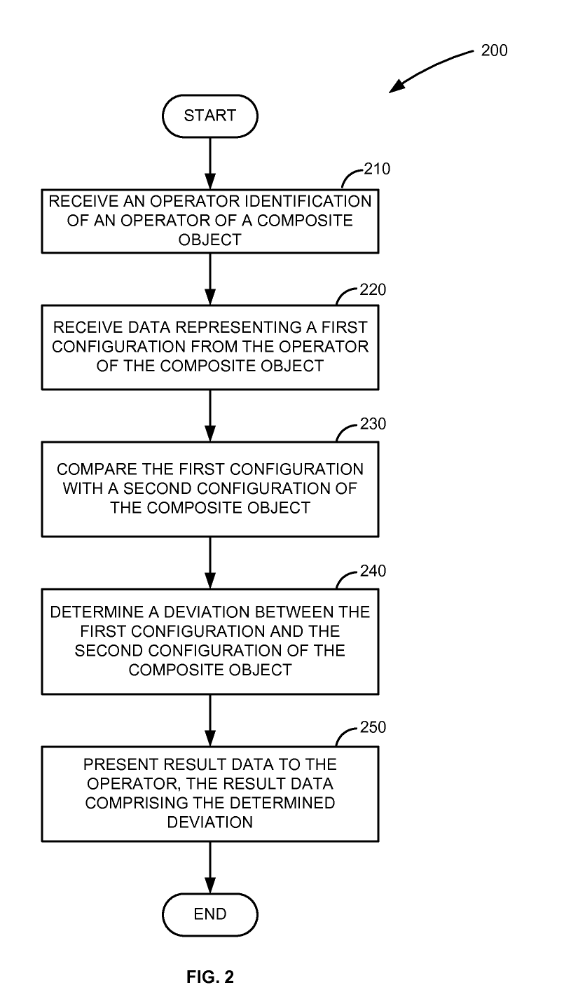

FIG. 2 is a flow diagram of an embodiment of a method 200 for remote comparison of a maintenance configuration with an allowable configuration. The method begins at block 210 with receiving an operator identification of an operator of a composite object. The operator identification is received in a remote server such as remote server 130. Then, at block 220, data representing a first configuration is received from the operator of the composite object at the remote server. In one embodiment, the first configuration is a maintenance configuration of the composite object. In one embodiment, the data representing the first configuration is received at the remote server from a server of the operator, such as operator's server 140.

Further, at block 230, the first configuration is compared to a second configuration of the composite object within the remote server. In one embodiment, the second configuration is an allowable configuration of the composite object. In one embodiment, the comparison, as described in block 230, includes extracting the second configuration from a repository, the second configuration indexed by the operator identification received at block 220 and comparing elements of the first configuration to corresponding elements of the second configuration. In one embodiment, the repository with the second configuration is contained within the remote server such as repository 135 within the remote server 130.

Turning back to FIG. 2, at block 240, a deviation between the first configuration and the second configuration of the composite object is determined. In one embodiment, this is performed by determining inconsistencies between elements of the first configuration and corresponding elements of the second configuration. Thus, by comparing the structures contained within the first configuration and the second configuration, the deviation is determined.

Then, at block 250, result data is presented to the operator of the composite object. The result data comprises the determined deviation at block 240. In one embodiment, the result data is sent to the operator through a report.

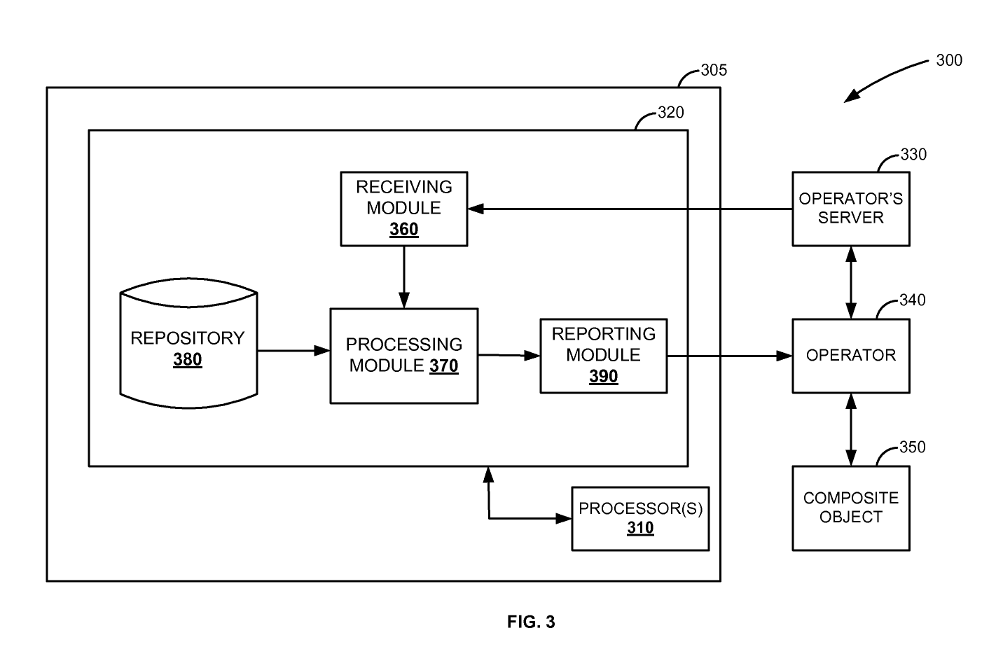

FIG. 3 is a block diagram of an embodiment of a system 300 for remote comparison of a maintenance configuration with an allowable configuration. The system includes a remote server 305 with one or more processors 310 for executing program code. Memory 320 is in connection to the one or more processors 310. The system 300 further includes an operator's server 330. The operator's server 330 persists information for the maintenance configuration of a composite object 350. The composite object 350 is utilized and maintained by an operator 340.

The remote server 305 further includes a receiving module 360 to receive an operator identification and data representing the maintenance configuration from the operator 340 of the composite object 350.

The remote server 305 also includes a processing module to compare the maintenance configuration with the allowable configuration and to determine a deviation between the maintenance configuration and the allowable configuration of the composite object 350. In one embodiment, the processing module 370 is operable to extract the allowable configuration from a repository 380, the allowable configuration indexed by the operator identification. In one embodiment, the repository 380 is contained in a database within the remote server 305.

In one embodiment, the processing module 370 is operable to compare elements of the maintenance configuration to corresponding elements of the allowable configuration.

In one embodiment, the processing module 370 is operable to determine inconsistencies between elements of the maintenance configuration and corresponding elements of the allowable configuration.

The remote server 305 further includes a reporting module 390 to present result data to the operator 340, the result data comprising the determined deviation by the processing module 370. In one embodiment, the reporting module provides the result data to the operator 340 in a report.

In one embodiment, the method, as described in FIG. 2, may be performed by components as described in FIG. 3. Referring to FIG. 2 and FIG. 3, at process block 210, an operator identification of an operator 340 of a composite object 350 is received by the receiving module 360. At process block 220, data representing a first configuration from the operator 340 of the composite object is received by the receiving module 360. At process block 230, the processing module 370 compares the first configuration with a second configuration of the composite object 350. At processing block 240, the processing module 370 determines a deviation between the first configuration and the second configuration of the composite object 350. At process block 250, the result data with the determined deviation is presented to the operator 340 through the reporting module 390.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

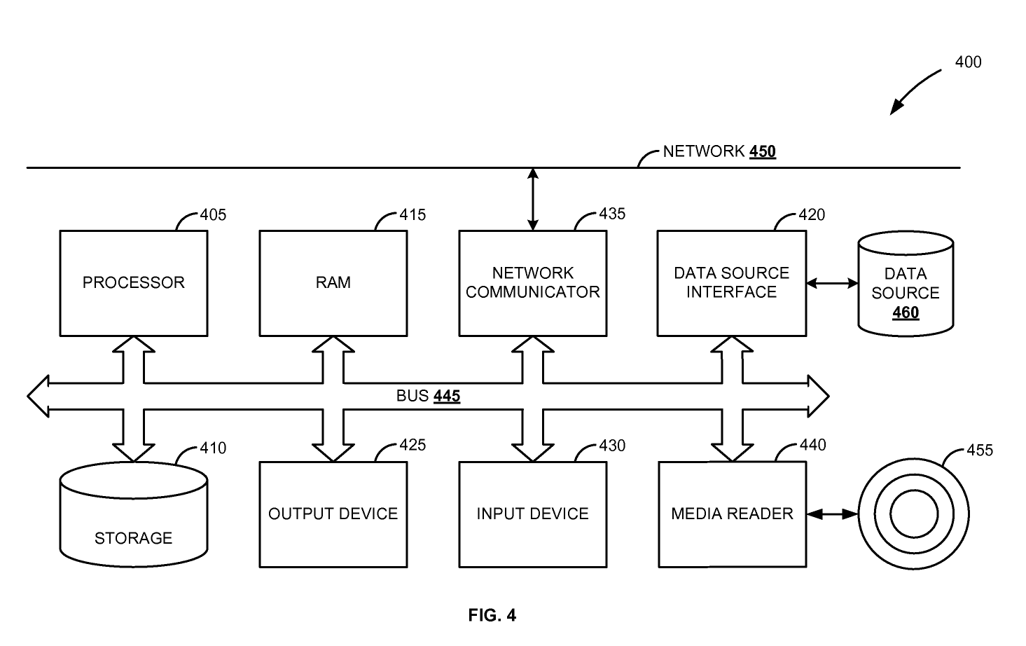

FIG. 4 is a block diagram of an exemplary computer system 400. The computer system 400 includes a processor 405 that executes software instructions or code stored on a computer readable storage medium 455 to perform the above-illustrated methods of the invention. The computer system 400 includes a media reader 440 to read the instructions from the computer readable storage medium 455 and store the instructions in storage 410 or in random access memory (RAM) 415. The storage 410 provides a large space for keeping static data where at least some instructions could be stored for later execution. The stored instructions may be further compiled to generate other representations of the instructions and dynamically stored in the RAM 415. The processor 405 reads instructions from the RAM 415 and performs actions as instructed. According to one embodiment of the invention, the computer system 400 further includes an output device 425 (e.g., a display) to provide at least some of the results of the execution as output including, but not limited to, visual information to users and an input device 430 to provide a user or another device with means for entering data and/or otherwise interact with the computer system 400. Each of these output devices 425 and input devices 430 could be joined by one or more additional peripherals to further expand the capabilities of the computer system 400. A network communicator 435 may be provided to connect the computer system 400 to a network 450 and in turn to other devices connected to the network 450 including other clients, servers, data stores, and interfaces, for instance. The modules of the computer system 400 are interconnected via a bus 445. Computer system 400 includes a data source interface 420 to access data source 460. The data source 460 can be accessed via one or more abstraction layers implemented in hardware or software. For example, the data source 460 may be accessed by network 450. In some embodiments the data source 460 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A computer implemented method for remotely comparing a first configuration to a second configuration of a composite object, the object maintained by an operator, the method comprising:
receiving an operator identification from the operator of the composite object at a remote server;
receiving data representing the first configuration from the operator of the composite object at the remote server;
comparing the first configuration with the second configuration of the composite object within the remote server;
determining a deviation between the first configuration and the second configuration of the composite object; and
presenting result data to the operator, the result data comprising the determined deviation.

2. The method of claim 1, wherein the first configuration is a maintenance configuration and the second configuration is an allowable configuration.

3. The method of claim 1, wherein the data representing the first configuration is received at the remote server from a server of the operator.

4. The method of claim 1, wherein comparing the first configuration with the second configuration further comprises:
extracting the second configuration from a repository, the second configuration indexed by the operator identification; and
comparing elements of the first configuration to corresponding elements of the second configuration.

5. The method of claim 4, wherein the repository is contained in a database within the remote server.

6. The method of claim 1, wherein determining the deviation between the first configuration and the second configuration of the composite object further comprises determining inconsistencies between elements of the first configuration and corresponding elements of the second configuration.

7. The method of claim 1, wherein presenting the result data to the operator, further comprises sending a report to the operator, the report comprising the determined deviation between the first configuration and the second configuration of the composite object.

8. A computer system for remotely comparing a maintenance configuration to an allowable configuration of a composite object including at least one processor for executing program code and memory, the system comprising:
a remote server;
a receiving module within the remote server to receive an operator identification and data representing the maintenance configuration from an operator of the composite object;
a processing module within the remote server to compare the maintenance configuration with the allowable configuration and to determine a deviation between the maintenance configuration and the allowable configuration of the composite object; and
a reporting module to present result data to the operator, the result data comprising the determined deviation.

9. The system of claim 8, wherein the processing module is further operable to extract the allowable configuration from a repository, the allowable configuration indexed by the operator identification.

10. The system of claim 9, wherein repository is contained in a database within the remote server.

11. The system of claim 8, wherein the processing module is further operable to compare elements of the maintenance configuration to corresponding elements of the allowable configuration.

12. The system of claim 8, wherein the processing module is further operable to determine inconsistencies between elements of the maintenance configuration and corresponding elements of the allowable configuration.

13. The system of claim 8, wherein the reporting module provides the result data to the operator in a report.

14. An article of manufacture including a non-transitory computer readable storage medium to tangibly store instructions, which when executed by a computer, cause the computer to:
receive an operator identification from an operator of a composite object at a remote server;
receive data representing a first configuration from the operator of the composite object at the remote server;
compare the first configuration with a second configuration of the composite object within the remote server;
determine a deviation between the first configuration and the second configuration of the composite object; and
present result data to the operator, the result data comprising the determined deviation.

15. The article of manufacture of claim 14, wherein the first configuration is a maintenance configuration and the second configuration is an allowable configuration.

16. The article of manufacture of claim 14, wherein the instructions to receive the data representing the first configuration from the operator of the composite object further comprise instructions, which when executed by a computer, cause the computer to receive the data representing the first configuration at the remote server from a server of the operator.

17. The article of manufacture of claim 14, wherein the instructions to compare the first configuration with the second configuration further comprise instructions, which when executed by a computer, cause the computer to:
extract the second configuration from a repository, the second configuration indexed by the operator identification; and
compare elements of the first configuration to corresponding elements of the second configuration.

18. The article of manufacture of claim 17, wherein the repository is contained in a database within the remote server.

19. The article of manufacture of claim 14, wherein the instructions to determine a deviation between the first configuration and the second configuration further comprise instructions, which when executed by a computer, cause the computer to determine inconsistencies between elements of the first configuration and corresponding elements of the second configuration.

20. The article of manufacture of claim 14, wherein the instructions to present the result data to the operator further comprise instructions, which when executed by a computer, cause the computer to send a report to the operator, the report comprising the determined deviation between the first configuration and the second configuration of the composite object.
